(19) United States
(12) Patent Application Publication
(10) Pub. No.: US 2013/0132733 A1
(43) Pub. Date: May 23, 2013

(54) System And Method For Digital Rights Management With System Individualization

(71) Applicants: Sunil C. Agrawal, Milpitas, CA (US); Katherine K. Nadell, San Jose, CA (US); Kunal D. Shah, Milpitas, CA (US)

(72) Inventors: Sunil C. Agrawal, Milpitas, CA (US); Katherine K. Nadell, San Jose, CA (US); Kunal D. Shah, Milpitas, CA (US)

(21) Appl. No.: 12/472,155

(22) Filed: May 26, 2009

(51) Int. Cl. G06F 21/00

(52) U.S. Cl. 713/189

(57) ABSTRACT

Various embodiments of a system and method for digital rights management with system individualization are described. In various embodiments, a DRM component may generate a request for machine-specific credentials specific to the system on which the DRM component is implemented. This request may include device information of component(s) of such system. The DRM component may also receive an encrypted response that includes the machine-specific credentials. This encrypted response may be encrypted with a machine-specific encryption key generated from the device information. In various embodiments the response may be generated by an individualization server that verified the request for machine-specific credentials. The DRM component may also, based on the device information of the system on which the DRM component is implemented, generate an encryption key equivalent to the machine-specific encryption key with which the received response is encrypted. The DRM component may decrypt the encrypted response with the generated encryption key.

### BACKGROUND

1. Field of the Invention

The present invention is directed to computer systems. More particularly, it is directed to digital rights management within a computing environment.

2. Description of the Related Art

In prior years it would not be uncommon for an individual to obtain content (e.g., literary works, periodicals, music, and movies) from a retail location in the form of a physical medium. For example, an individual might travel to a local bookstore and purchase written works in the form of a book, newspaper, or magazine. In another example, an individual might purchase music stored on a Compact Disc (CD) or a motion picture stored on a Digital Video Disc (DVD). In recent years the ubiquity of the Internet and the World Wide Web has paved the way for alternative methods of obtaining content. For example, a user might log on to a music retailer's website and download a digital version of a music album. In other example, a user might log on to a movie subscription provider's website to download or stream a motion picture to view on a personal computer. In the case of books, a user might log on to a bookseller's website and download an electronic book (“e-book”) for view on a computer system, such as a desktop computer or a handheld e-book reader.

The Internet and World Wide Web serve as a backbone for numerous file sharing mechanisms. Examples of such mechanisms include electronic mail (“email”) and more advanced file distribution software, such as peer-to-peer (“P2P”) file sharing applications. In many cases, such file sharing mechanisms are often utilized to distribute electronic content to individuals that are not authorized to access such content. Such distribution is likely due in part to the relative ease and anonymity of sharing files through such mechanisms. To combat unauthorized consumption of content, some content owners have adopted an approach to protecting their content known as digital rights management (“DRM”), which may include various techniques for limiting access of electronic content to authorized individuals.

### SUMMARY

Various embodiments of a system and method for digital rights management with system individualization are described. In various embodiments, a DRM component of a client system may control access to acquired content, which may be protected (e.g., encrypted). For instance, the DRM component may be responsible for decrypting protected content and enforcing usage rights on such content. In various embodiments, the DRM component may be configured to implement a process for individualizing the system on which the DRM component is implemented. For instance, the DRM component may be configured to generate a request for machine-specific credentials specific to the system on which the DRM component is implemented. This request may include device information (e.g., one or more identifiers) of one or more components (e.g., a processor, motherboard, network interface unit, or some other component) of such system. The DRM component may also be configured to receive an encrypted response that includes the machine-specific credentials. This encrypted response may be encrypted with a machine-specific encryption key generated from the device information (from the request). In various embodiments the response may be generated by an individualization server that verified the request for machine-specific credentials. The DRM component may also be configured to, based on the device information of the system on which the DRM component is implemented, generate an encryption key equivalent to the machine-specific encryption key with which the received response is encrypted. The DRM component may be configured to decrypt the encrypted response including the machine-specific credentials with the generated encryption key. In various embodiments, the machine-specific credentials determined by decrypting the response may be utilized by the DRM component to obtain one or more content licenses for protected content.

### BRIEF DESCRIPTION OF THE DRAWINGS

FIG. 1 illustrates a data flow diagram of the packaging, distribution and acquisition of content, according to various embodiments.

FIG. 2 illustrates a block diagram of a DRM framework of the system and method for digital rights management with system individualization, according to various embodiments.

FIG. 3 illustrates a flowchart of an example method that may be implemented by digital rights management component, according to various embodiments.

FIG. 4 illustrates a flowchart of another example method that may be implemented by digital rights management component, according to various embodiments.

FIG. 5 illustrates an example system configuration for the digital rights management system, according to various embodiments.

FIG. 6 illustrates an example computer system suitable for implementing various components of the system and method for digital rights management with system individualization, according to various embodiments.

While the system and method for digital rights management with system individualization is described herein by way of example for several embodiments and illustrative drawings, those skilled in the art will recognize that the system and method for digital rights management with system individualization is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the system and method for digital rights management with system individualization as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. In various portions of the description presented herein, the terms “validate”, “verify”, “validation”, “verification”, “validating”, and “verifying” may be used interchangeably.

### DETAILED DESCRIPTION OF EMBODIMENTS

Various embodiments of a system and method for digital rights management with system individualization are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Note that the description presented herein may include one or more references to a one-way function or a cryptographic hash function, either of which may be referred to herein as simply a hash function. In various embodiments, the hash functions described herein may be any of various hash functions including, but not limited to, the Secure Hash Algorithm (SHA) (e.g., SHA-1, SHA-0, SHA-224, SHA-256, SHA-384, SHA-512, and other SHA variations), the RACE Integrity Primitives Evaluation Message Digest (RIPEMD) (e.g., RIPEMD-128, RIPMED-160, RIPEMD-256, RIPEMD-320, and other RIPEMD variations), the Message Digest algorithm (MD) (e.g., MD-3, MD-4, MD-5, and other MD variations), the Tiger and Tiger2 hash functions (e.g., Tiger-128, Tiger-160, Tiger-192, Tiger2-128, Tiger2-160, Tiger2-192, and other Tiger variations), the Very Efficient Substitution Transposition (VEST) (e.g., VEST-4, VEST-8, VEST-16, VEST-32, and other VEST variations), the WHIRLPOOL hash function, some other hash function whether presently known or developed in the future, and/or some combination or variation of any of the aforesaid hash functions.

Various embodiments include various encryption and/or decryption keys, any of which may be generated via a key derivation function (KDF). Key derivation functions may include one or more iterations or instances of hash functions and/or other cryptographic operations in order to generate an encryption or decryption key. Examples of key derivation function may include but are not limited to any key derivation functions specified by Public Key Cryptography Standards (PKCS) (e.g., PKCS-5) or Adobe Password Security. In various embodiments, KDFs may be utilized by any of the various components described herein to generate keys for symmetric encryption.

Various portions of this detailed description may refer to “client(s)” and “server(s).” For instance, various embodiments may include (among other elements) a client system (or simply a “client”), an individualization server, and/or a license server. It should be understood that the terms “client” and “server” do not impose any limitation on the operation, configuration, or implementation of such elements. It should be understood that these terms are used only as convenient nomenclature. Indeed, various embodiments are in no way limited by the principles of a conventional client-server architecture. For instance, any of the “clients” or “servers” described herein may be configured to communicate according to a variety of communication protocols or system architectures, such as a peer-to-peer (P2P) architecture or some other architecture, whether such architecture is presently known or developed in the future.

In various instances, this detailed description may refer to content (which may also be referred to as “content data,” “content information” or simply “data” or “information”). In general, content may include any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to Adobe® Flash® Video (.FLV) format or some other video file format whether such format is presently known or developed in the future.

In various embodiments, content may include electronic representations of music, spoken words, or other audio, which may include but is not limited to data files adhering to the MPEG-1 Audio Layer 3 (.MP3) format, Adobe® Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, Adobe® Photoshop® (.PSD) format or some other format for electronically storing text, graphics and/or other information whether such format is presently known or developed in the future. In some embodiments, content may include any combination of the above-described examples.

In various instances, this detailed disclosure may refer to consuming content or to the consumption of content, which may also be referred to as “accessing” content, “viewing” content, “listening” to content, or “playing” content, among other things. In some cases, the particular term utilized may be dependent on the context in which it is used. For example, consuming video may also be referred to as viewing or playing the video. In another example, consuming audio may also be referred to as listening to or playing the audio.

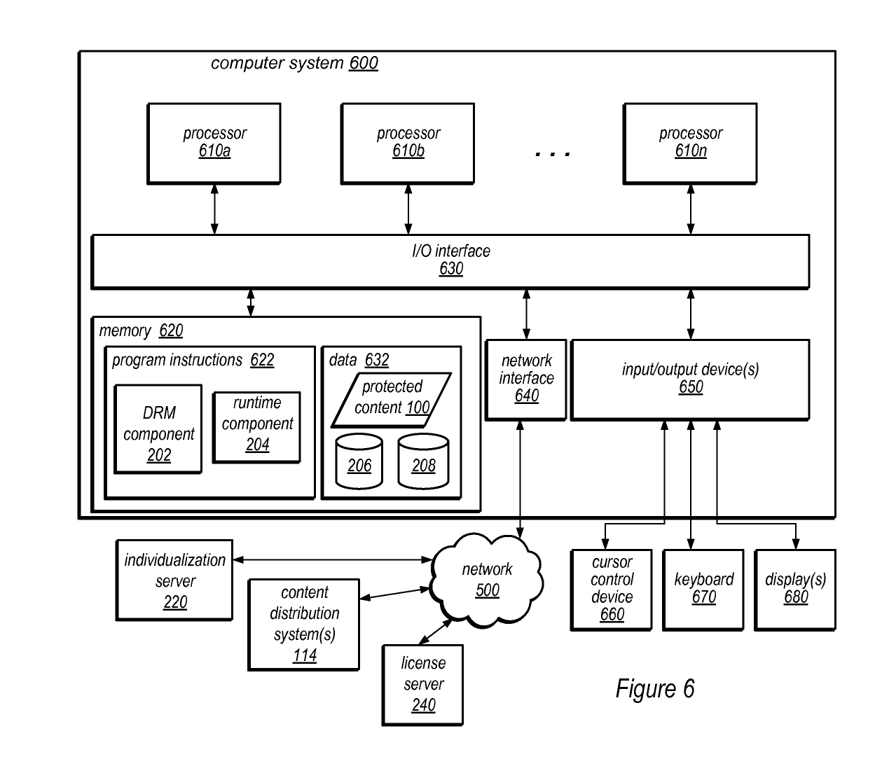

In various instances, this detailed description may refer to a device on which content may be consumed. In various embodiments, such a device may include but is not limited to a computing system (e.g., a desktop or laptop computer), a digital audio or multimedia player (e.g., an MP3 player), a personal digital assistant (PDA), a mobile phone, a smartphone, an e-book reader, a digital photo frame, or any other device or system configured to access, view, read, write, and/or manipulate any of the content data described herein. Any of such devices may be implemented via a computer system similar to that described with respect to FIG. 6.

Note that in various instances the description presented herein may refer to a given entity performing some action. It should be understood that this language may in some cases mean that a system (e.g., a computer system) owned and/or controlled by the given entity is actually performing the action.

### Introduction

Various embodiments of the system and method for digital rights management with system individualization may include a digital rights management (DRM) framework configured to provide access to protected content (e.g., content that is encrypted and/or subject to usage rights) in response to the successful completion of a DRM process. As described in more detail below, such DRM verification process may include the coordinated efforts of multiple systems including a system on which the consumption of content is attempted (e.g., a client system), an individualization server (which may also be referred to as an “individualization component”) (described in more detail below) and a license server system configured to provide content licenses enabling the consumption of protected content. The client system may in various embodiments include a DRM component (e.g., on a client computer system) configured to carry out DRM operations (e.g., decrypting content and/or enforcing usage rules) such that the content can be consumed (e.g., viewed, played, etc.). One particular example of a DRM component includes Adobe® DRM Client for Flash® Player.

In various embodiments, elements of the DRM framework may be configured to perform a process that includes the individualization of a system (e.g., a client computer system) that implements the DRM component. Individualization may include assigning unique credentials (which may be referred to herein as “machine-specific credentials” or simply “machine credentials”) to a computer system that implements an instance of a DRM component (e.g., an executing instance of a DRM component stored in memory on a particular computer system). An example of a machine credential may include a private key for the client system and a certificate that includes an associated public key for the client system. In various embodiments, a machine credential may be based on device information of the client system on which the DRM component is implemented. For instance, the unique machine credential assigned to a particular client system may be generated based on a processor identifier, a motherboard identifier, and/or some other information associated that system (which is described in more detail below).

In various embodiments, a given unique machine credential may be bound or tied to a particular client system through a variety of techniques. (Note that binding or tying a unique credential to a particular computer system may in various embodiments mean that, other than the system that created the machine credential, only that particular computer system has access to the unencrypted version of that unique machine credential.) In some embodiments, the unique machine credential may be provided by an individualization server (described in more detail below). Moreover, the individualization server may be configured to, based on device information (e.g., processor identifier, motherboard identifier, and/or other device information) associated with the system implementing the DRM component, generate a machine-specific encryption key specific to that client system. For instance, the individualization server might utilize a particular algorithm, function, and/or executable logic to generate the machine-specific key based on device information of the system implementing the DRM component. To bind the machine credentials to the particular client system, the individualization server may be configured to encrypt the machine credentials for the client system with the machine-specific encryption key generated for that client system.

In various embodiments, the client machine on which the DRM component is implemented may receive the encrypted machine credentials (e.g., credentials encrypted with the machine-specific encryption key). The DRM component may generate a machine-specific encryption key with which to decrypt the encrypted machine credentials. If performed correctly, this key generation process may result in a machine-specific key that is the same as the machine-specific encryption key generated by the individualization server (described above). For example, the DRM component may be configured to use the same logic (e.g., a particular algorithm, function, and/or executable logic) utilized by the individualization server to generate a machine-specific encryption key based on the same device information (e.g., processor identifier, motherboard identifier, and/or other device information) of the client system.

In various embodiments, the machine credentials are stored within the client system in encrypted form (e.g., as encrypted by the individualization server). Since in various embodiments only the client system has access to the appropriate information (e.g., device information and the logic for generating a machine-specific decryption key based on that device information) for decrypting the machine credentials, the machine credentials can be considered as bound to the client system. Exceptions to this may in some cases include trusted third parties. For instance, while the individualization server may be configured to generate such a decryption key, the individualization server may be considered a trusted third party (e.g., a party that is not a security threat to the integrity of the machine credentials or the overall DRM system). In some embodiments, other techniques may be utilized to bind the machine credentials to the client system. For instance, various embodiments may utilize a run-time verification of the device information utilized for system individualization against the current device information of the client system. If the verification is successful, the client system may be permitted to use the machine credentials. If the verification is not successful, the client system may be prohibited from using the machine credentials.

Note that the encrypted form in which the machine credentials are stored on the client machine may be but need not be the same as the encrypted form in which the machine credentials are received from the individualization server.

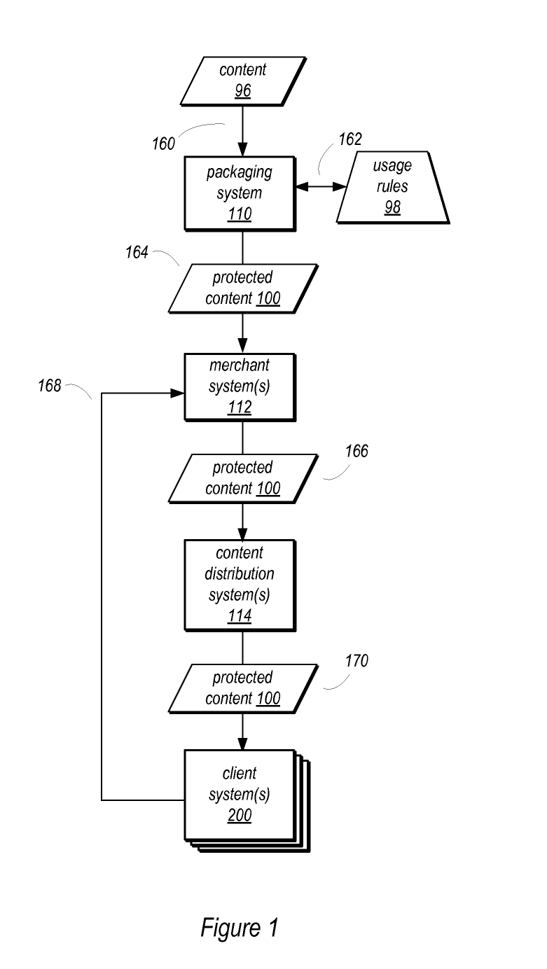

The machine credentials obtained by the client may be utilized to obtain access to content. For instance, the client system may obtain encrypted content from a variety of sources (e.g., as described with respect to FIG. 1 below). To obtain the content license for that content, the DRM component may be configured to submit a license request to a license server. The license request may in various embodiments include at least a portion of the machine credentials described above. In some embodiments, the license request may include a digital certificate (from the machine credentials) that includes an identifier of the client system and a corresponding public key. In various embodiments, such certificate may be digitally signed by a trusted third party (which may be, e.g., a certificate authority or the individualization server). In various embodiments, the digital signature may indicate that the signing party attests to the validity of the information within the certificate. The license request may include other information (e.g., a username or other user identifier, a content identifier of the content for which a license is requested, etc.) as described in more detail below. The license server may be configured to perform one or more verifications on which the issuance of a content license is dependent. For instance, the license server may ensure that the client system is not on a machine revocation list (e.g., a list that identifies machines known to be security threats or otherwise unsuitable for receiving a content license) and that the user is authorized to access the content (note that other checks or verification are described in more detail below). In response to performing all of the appropriate verifications, the license server may issue the content license to the client system. In various embodiments, the license server may bind the content license to the client machine. For example, the license server may access a public key from a digital certificate provided by the client system in the license request; this digital certificate may be the digital certificate from the machine credentials issued to the client system by the individualization server. The license server may in various embodiments encrypt the content license with this public key. In this way, only a system that holds the corresponding private key (e.g., the client system) may be able to decrypt the content license; note that this private key may be the private key from the machine credentials issued to the client system by the individualization server.

Subsequent to receiving the encrypted content license, the DRM component on the client system may decrypt the content license with the private key from the machine credentials (e.g., since the license server may have encrypted the content license as described above). In various embodiments, the DRM component may access the content license and usage rules (if any) from the content license and decrypt the corresponding content. If usage rules are present, the DRM component may enforce restrictions set forth by those rules (e.g., enforcing a rental period for the content).

### Overview of Content Packaging, Distribution, and Acquisition

FIG. 1 illustrates a flow diagram representing the packaging, distribution, and acquisition of protected content according to various embodiments. Content 96 may represent any of the content described above (e.g., videos, music, etc.). In many cases, content 96 may be stored in “clear” form, such as an unencrypted state. At 160 content 96 may be provided to packaging system 110. For instance, a content owner may provide content 160 to an entity controlling packaging system 110, such as an entity that provides packaging and encoding services for digital content. Packaging system 110 may also be configured to receive (or generate) usage rules, such as usage rules 98 (see e.g., 162). Usage rules 98 may include any restrictions on the use, access, or consumption of the content including but not limited to restricting the access of content to a particular time period (e.g., a rental time period or some other time period), restricting the actions (e.g., view, copy, save, distribute, etc.) that can be performed with respect to the protected content, and/or some other restriction on the content (e.g., a restriction might ensure content be viewed with embedded advertising content). Note that various system (e.g., a merchant system) might modify the usage rules at a later point in time. For instance, if a merchant sells a movie rental, the merchant may modify usage rules to specify a rental period for the movie.

Packaging system 110 may generate protected content 100 based from content 96 and usage rules 98. The generation of protected content 100 may in various embodiments include encrypting content 96. For instance, the content may be encrypted with a content encryption key via a symmetric encryption process. (Note that this content encryption key may in some cases be the key that is included in a content license for the content, which is described in more detail below.) In some cases, to generate protected content 100, packaging system 110 may be configured to encode content 96 according to various codecs (e.g., video compression codecs, an example of which includes video codecs utilized to generate Adobe® Flash® Video files).

As illustrated at 164, packaging system 110 may be configured to provide protected content 100 to one or more merchant system(s) 112. In one example, merchant system(s) 112 may include one or more computer systems for implementing an electronic commerce (“e-commerce”) portal. One example of an e-commerce portal includes an e-commerce website that offers content (and possibly other items) as the basis for a commercial transaction (e.g., sale, rent, trade, auction, etc.). While in some embodiments merchant system(s) 112 may be configured to provide protected content 100 directly to client systems 200 via one or more data networks, in the illustrated embodiment merchant system 112 may provide protected content 100 to one or more intermediate systems (as illustrated by 166). In the illustrated example, such an intermediate system might include content distribution system(s) 114, which may include a content distribution network (CDN). In various embodiments, such CDN may be optimized for the high-speed transfer of data including multi-media content and/or other types of content.

As illustrated at 168, one or more client system(s) 200 may submit a request for content. This request can include a variety of information including but not limited to user information, such as authentication information (e.g., a username and password or some other authentication information for identifying a user or customer). The request may include but is not limited to transaction-related information, such as payment information (e.g., credit card numbers, bank account numbers, billing addresses, etc.). The request may include but is not limited to information for identifying the content requested, such as a content identifier or other information for identifying the particular content requested.

Merchant system 112 may accept or reject the request issued at 168 (e.g., based on the information included in the request). If the request is rejected, client system 200 may not be provided with access to the requested content. If the request is accepted, client system 200 may be allowed to receive the protected content 100 as illustrated at 170. For instance, a client system 200 may download protected content 100 from content distribution system(s) 114 via the Internet and/or other data networks. Client system(s) 200 may store any acquired protected content in local memory. Note that in addition to the content itself, client system 200 may in some cases need the corresponding content license to consume the content (e.g., the unprotected or unencrypted version of the content). For instance, the content license may include the correct encryption key for decrypting the protected content.

Note that in some embodiments, client system(s) 200 may acquire protected content according to techniques different than those described above. For instance, various ones of client(s) 200 may obtain protected content from sources other than content distribution system(s) 114. For example, one or more of client systems 200 operating in a P2P environment may distribute encrypted content according to one or more P2P protocols.

Also note that in addition to obtain protected content, client system 200 may in various embodiments be configured to obtain DRM component 202 (e.g., obtained along with the content). For instance, in some embodiments, bootstrapping logic may be obtained (e.g., via runtime component 204 or content distribution systems 114), and the client system 200 may be configured to execute the bootstrapping logic to obtain (e.g., download) DRM component 202 at runtime.

### System Individualization

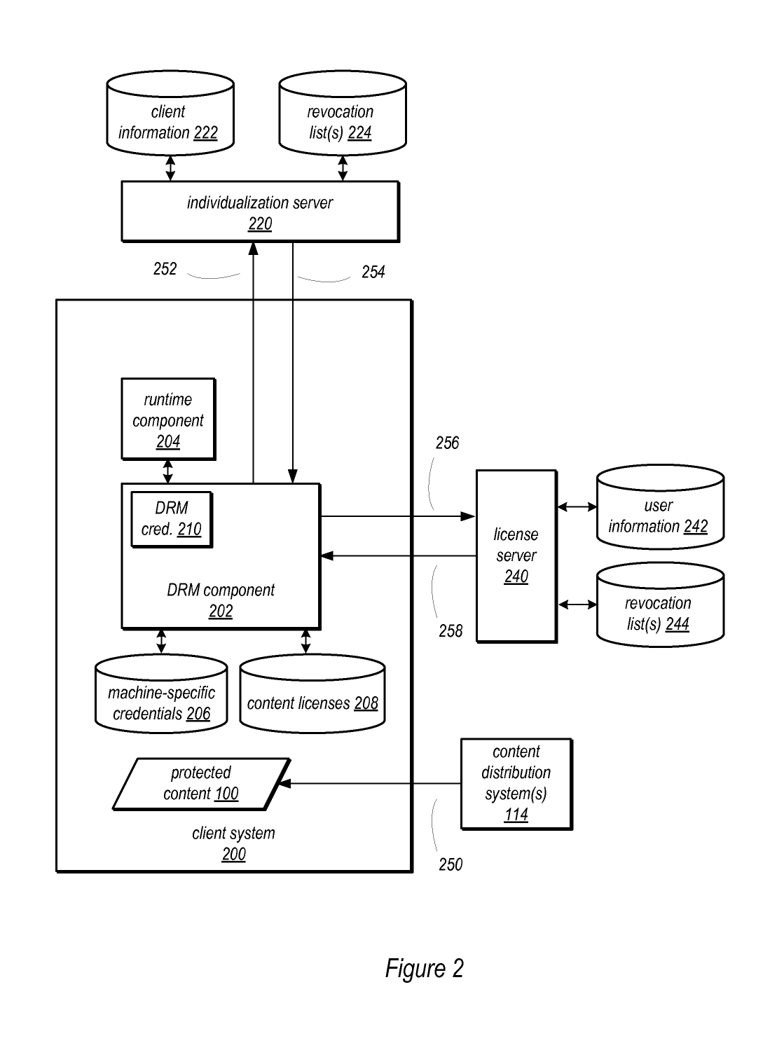

FIG. 2 illustrates a block diagram of a system configured to implement system individualization as well as other aspects of various embodiments (e.g., diversification, etc.). In various embodiments, a client system 200 may receive one or more portions of protected content 100 from a content distribution system 114, such as described above with respect to FIG. 1. Note that client system 200 may in various embodiments obtain protected content 100 from other sources (e.g., directly from an e-commerce portal).

Client system 200 may in various embodiments include a DRM component 202 configured to carry out DRM operations (e.g., decrypting content and/or enforcing usage rules) such that the protected content 100 can be consumed (e.g., viewed, played, etc.). In various embodiments, DRM component 202 may be configured to be individualized. As described above, individualization may include assigning machine credentials specific to a computer system that implements an instance of a DRM component (e.g., client system 200). One example of a machine credential may include a private key for client system 200 and a certificate that includes an associated public key for client system 200. In various embodiments, a machine credential may be based on device information of client system 200.

In various embodiments, DRM component 202 may request machine-specific credentials from individualization server 220, as illustrated at 252. As described in more detail below, the machine credentials may be utilized to obtain a content license from license server 240. The request sent at 252 may include various portions of device information. Such device information may include device information of various components or elements of client system 200 including but not limited to a processor identifier, a motherboard identifier, and/or some other information associated with that system (which is described in more detail below). In some cases, device information may include information from one or more technical prevention measure(s) (TPM) components (e.g., a TPM semiconductor component). One example of a TPM component may include a security dongle coupled to client system 200 (e.g., via a universal serial bus (USB) connection). Other examples of device information may include but are not limited to a Basic Input/Output System (BIOS) identifier, a hard drive identifier, a plug-and-play identifier (PNPID), a network interface unit address and/or a serial number of client system 200.

In some embodiments, the device information in request 252 may be modified by DRM component 202 through one or more processes, algorithms or logic prior to inclusion in the request. For instance, in some embodiments, DRM component 202 may obtain multiple identifiers from multiple components of client system 200. DRM component 202 may apply a hash function (e.g., SHA-1 or any of the other cryptographic hash functions described herein), encryption, and/or other logic to these identifiers (either individually or across all of the identifiers as a group) prior to including such information in request 252. In various embodiments, the processes, algorithms, and/or logic performed on the device information prior to inclusion in the request may be performed to ensure the privacy of the device information. Additionally, any process, algorithm, or logic applied to the device information may be indicated within request 252. Other information, such as identifying information of DRM component 202 or an operating system running on client system 200, may be included within request 252.

In various embodiments, DRM component 202 may include a nonce or session identifier within request 252. Individualization server 220 may utilize such information to ward off replay attacks on the server. For instance, individualization server 220 may include a record of previously received nonces and reject any request that includes a nonce already present in such record.

In various embodiments, various digital signatures may be applied to the request. This may assist individualization server 220 in verifying that request 252 is actually sent by client system 200. In various embodiments, runtime component 204 may include a runtime credential (not illustrated) that includes a public key—private key pair. Similarly, DRM component 202 may include DRM credential 210 that includes a public key—private key pair. Either or both of these credentials may be used to digitally sign response 252. One example of digitally signing the request may include performing a hash of the request, asymmetrically encrypting the hash result with the private key (from either of the credentials), and appending the encrypted hash result (i.e., the digital signature) to result 252. Individualization server 220 may be configured to verify any digital signature of request 252 (such as by utilizing the public keys of DRM credential 210 and/or the credential associated with runtime component 204).

In various embodiments, DRM component 202 may also encrypt request 252 with a public key of individualization server 220. In various embodiments, this public key may be obtained from a digital certificate (e.g., an X.509 certificate) from a certificate authority or other entity. Encrypting request 252 in this manner may protect the request from being deciphered by an attacker or other entity monitoring communications between the DRM component and the individualization server.

Individualization server 220 may be configured to issue machine-specific credentials to client system 200 (assuming various conditions have been met) in response to processing request 252. Processing request 252 may include the individualization server decrypting the request with a private key specific to individualization 220 (e.g., as described above, the request may have been encrypted with the corresponding public key of the individualization server). Individualization server 220 may also be configured to verify any of the digital signatures that may have been applied to request 252 (described above). If request 252 also includes a nonce, the individualization server 220 may perform replay attack protection by ensuring that the nonce has not been received before and rejecting the request if the nonce has been received before.

Based on the device information in the request, individualization server 220 may be configured to generate machine-specific credentials specific to client system 200. These machine-specific credentials may include a private key—public key pair specific to client system 200. In various embodiments, the machine credentials may include a digital certificate (e.g., X.509 certificate or some other type of digital certificate) that includes the public key. The digital certificate may also include an identifier specific to client system 200. In various embodiments, such certificate may be digitally signed by a trusted third party (which may be, e.g., a certificate authority or the individualization server). In various embodiments, the digital signature may indicate that the signing party attests to the validity of the information within the certificate. In some embodiments, the client system identifier in the certificate might be a random identifier (e.g., a random number) generated by the individualization server. The individualization server may keep a record indicating a mapping of the identifier of the certificate to the device information of client system 200 (e.g., mapped in a record of client information 222).

In some embodiments, individualization server 220 may use information derived from the device information included in the request to generate the identifier of the digital certificate of the machine credentials. For instance, as described above, the device information received by the individualization server 220 may have been hashed or otherwise modified by DRM component. In some embodiments, it may not be prudent to include this information within the digital certificate of the machine-specific credentials because an attacker could conceivably perform a brute force attack on the information to obtain a clear text form of the device information. This vulnerability may in some cases be caused by device information that lacks entropy. For instance, some device information might be restricted to a relatively small range (e.g., numerical identifiers ranging from 0-9, or some other range) over which it would not be computationally or temporally prohibitive for an attacker to perform a brute force attack. Such vulnerabilities may pose a privacy concern. To overcome this situation, individualization server may apply a widening function, such as a function configured to generate a Hash Message Authentication Code “HMAC”), to the device information (or the hash of the device information if it is received in hashed form). Applying such a widening function to the device information to create a result that can be used as the identifier included within the certificate of the machine credentials may prevent an attacker from utilizing brute force attacks to determine the device information or the algorithms, processes, or logic utilized to create such device information. Accordingly, systems (e.g., license server 240) that obtain the digital certificate of the machine credentials may not be able to determine the device characteristics specified by the device information.

As described above, the client system identifier in the digital certificate of the machine credentials may be a random identifier or an identifier based on the device information of the client system. In various embodiments, the digital certificate may include both of such identifiers. When the license server processes a license request that includes such a digital certificate, the license server may evaluate either (or possibly both) of the two identifiers for license provisioning depending on the nature of the license request (e.g., whether the request is an authenticated request or an anonymous request) (this process is described in more detail below with respect to content license acquisition).

In various embodiments, individualization server 220 may store the machine-specific credentials that it generates within client information 222. Note that client information 222 may in various embodiments include, for a given client system, stored records of the clients system's device information, machine identifier and machine credentials.

In various embodiments, revocation list(s) 224 may include records of systems that have been revoked or determined to be ineligible for receiving machine credentials. In various embodiments, individualization server may ensure that an identifier of client system 200 is not present in such records prior to issuing machine-specific credentials to the client system.

In various embodiments, individualization server 220 may bind or tie machine credentials to client system 200. For instance, individualization server 200 may be configured to, based on device information (e.g., processor identifier, motherboard identifier, and/or other device information described above) associated with client system 200, generate a machine-specific encryption key specific to that client system. Note that this machine-specific encryption key may be distinct from the machine-specific credentials. The individualization server may be configured to utilize a particular algorithm, function, and/or executable logic (e.g., one way functions, hash functions, key derivation functions) to generate the machine-specific key based on device information of the system implementing the DRM component. To bind the machine credentials to the particular client system, the individualization server may be configured to encrypt the machine credentials for the client system with the machine-specific encryption key generated for that client system. As described in more detail below, since client system 200 may in some cases be the only other system that can generate this same machine-specific encryption key, the machine credentials (which may be encrypted with the machine-specific encryption key) may be bound to client system 200.

Individualization server 220 may generate a response 254 which may include the machine credentials encrypted with the machine-specific encryption key. Client machine 200 may receive the encrypted machine credentials (e.g., credentials encrypted with the machine-specific encryption key). The DRM component may generate a machine-specific encryption key with which to decrypt the encrypted machine credentials. If performed correctly, this key generation process may result in a machine-specific key that is the same as the machine-specific encryption key generated by the individualization server 220. For example, DRM component 202 may be configured to use the same logic (e.g., a particular algorithm, function, and/or executable logic) (e.g., a hash function, one-way function, or key derivation function) utilized by individualization server 220 to generate a machine-specific encryption key based on the same device information (e.g., processor identifier, motherboard identifier, and/or other device information) of the client system.

In various embodiments, the machine credentials are stored within the client system in encrypted form (e.g., as encrypted by the individualization server) as illustrated by machine-specific credentials 206. Since in various embodiments only the client system has access to the appropriate information (e.g., device information and the logic for generating a machine-specific decryption key based on that device information) for decrypting the machine credentials, the machine credentials can be considered as bound to the client system. Exceptions to this may in some cases include trusted third parties. For instance, while individualization server 220 may be configured to generate such a decryption key, the individualization server may be considered a trusted third party.

Note that the encrypted form in which the machine credentials are stored on client system 200 may be but need not be the same as the encrypted form in which the machine credentials are received from individualization server 220. For example, the encrypted machine credentials received from individualization server 220 at 254 may be encrypted with a machine-specific encryption key generated by the individualization server via particular logic (e.g., a particular algorithm, function, and/or executable logic) and based on particular device information (e.g., processor identifier, motherboard identifier, and/or other device information) of the client system. For instance, the particular device information may be the input to the particular logic, and the output may be the machine-specific key. In some cases, the encrypted machine credentials may be stored securely on the client system in the encrypted form in which they are received from the individualization server. In other cases, DRM component 202 may decrypt the encrypted machine credentials received from the individualization server and re-encrypt the machine credentials with a different encryption process than that used by the individualization server. For instance, this re-encryption process may include utilizing logic (e.g., a particular algorithm, function, and/or executable logic) different than that used by the individualization server and/or utilizing a different combination of device information (e.g., processor identifier, motherboard identifier, and/or other device information) than that utilized by individualization server 202. In some cases, this may result in the client DRM component encrypting the machine credentials with a machine-specific encryption key that is different than the machine-specific encryption key utilized by the individualization server. In any case, the machine credentials stored on the client system may be encrypted or otherwise protected by a machine-specific key that is based on device information of client system 200. In this way, the machine credentials may be bound to the client system when stored on the client system. For instance, if the encrypted machine credentials of the client system were transferred to another computer system, that computer system would not be able to determine the unencrypted version of such machine credentials (e.g., since it may not have knowledge of what logic was used to generate the machine-specific encryption key and/or the device information that was used to generate the machine-specific encryption key).

### Content License Acquisition

The machine credentials obtained by client system 200 may be utilized to obtain access to a content license, which may be used to access a clear or unencrypted version of protected content 100 (e.g., for consumption, such as video playback). To obtain the content license for protected content 100, DRM component 202 may be configured to submit a license request 256 to license server 240. The license request may in various embodiments include at least a portion of machine specific credentials 206. In some embodiments, the license request may include a digital certificate that includes an identifier of the client system and a corresponding public key. As described above, in various embodiments, such certificate may be digitally signed by a trusted third party (which may be, e.g., a certificate authority or the individualization server). In various embodiments, the digital signature may indicate that the signing party attests to the validity of the information within the certificate. The license request may include other information (e.g., a username or other user identifier, a content identifier of the content for which a license is requested, etc.). In some embodiments this information may be obtained from metadata of protected content 100. In some cases, this metadata may not be encrypted as is the rest of protected content 100 (e.g., the actual content to be consumed) in various embodiments.

As described above, the digital certificate in the license request may in some embodiments include both a randomly generated identifier of the client system and an identifier of the client system generated based on device information of the client system. When the license server processes a license request that includes such a digital certificate, the license server may evaluate either (or possibly both) of the two identifiers for license provisioning depending on the nature of the license request (e.g., whether the request is an authenticated request or an anonymous request).

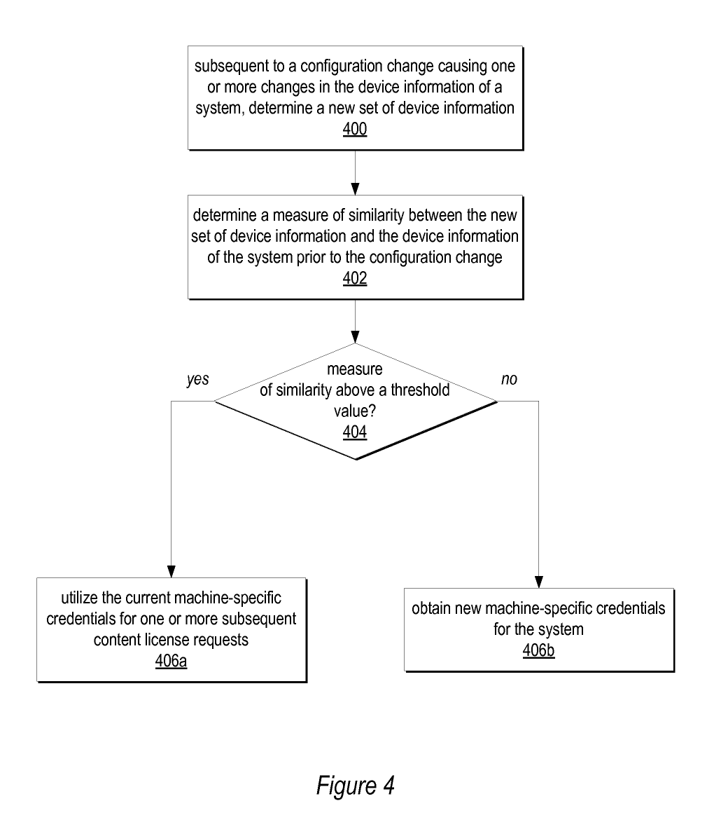

For authenticated requests (e.g., request that include user authentication information), the license server may track such requests on a per user basis (e.g., by storing corresponding records in user information 242) such that the license server associates a given user with a given client machine. For instance, for an original request associated with a user, the license server may store the device information-based identifier in a record associated with that user. For each subsequent request associated with the user, the license server may determine whether the request originates from the same machine by comparing the device information-based identifier in the received request to the device information-based identifier in the record associated with the user. Note that in various embodiments this comparison may allow for some changes to the device information over subsequent requests (e.g., by utilizing techniques similar to those described with respect to block 404 of FIG. 4 described below). For anonymous requests (e.g., request that do not include such user authentication information), the license server may utilize the randomly generated identifier in the digital certificate instead of the device information-based identifier.

Note that in various embodiments DRM component 202 may obtain a digital certificate for license server 240. The DRM component may be configured to encrypt request 256 with a public key from that digital certificate. License server 240 may be able to decrypt such a request with a corresponding private key. In various embodiments, request 256 may also be digitally signed with private keys from DRM credentials 210 or credentials associated with the runtime component 204 (similar to the digital signatures that may be applied to request 252, as described above). License server may be able to verify the authenticity of such digital signatures with public keys of the aforesaid credentials (similar to the signature verification process that may be performed by individual server 220, as described above).

The license server may be configured to perform one or more verifications on which the issuance of a content license for protected content 100 is dependent. For instance, the license server may ensure that the client system is not on machine revocation list(s) 244 (e.g., a list that identifies machines known to be security threats or otherwise unsuitable for receiving a content license) and that the user is authorized to access the content (note that other checks or verification are described in more detail below). (Note that in some cases revocation lists 244 may receive updated revocation information from revocation lists 224 and/or be synchronized with revocation lists 224.) For instance, user information 242 may contain a list of users and/or clients systems that are authorized to access content. For instance, request 256 may include an identifier (e.g., a username etc.) of a user of client system 200 and user information 242 may include records of users that have purchased or rented various content. In some cases, this information may be obtained from an e-commerce portal system that sells or rents content to various users and their associated client systems.

In response to performing all of the appropriate verifications, license server 240 may provide the content license to the client system, as illustrated by 258. In various embodiments, the license server may bind the content license to the client machine. For example, the license server may access a public key from a digital certificate provided by the client system in the license request; this digital certificate may be the digital certificate from the machine-specific credentials 206 issued to the client system by individualization server 220. The license server may in various embodiments encrypt the content license with this public key. In this way, only a system that holds the corresponding private key (e.g., client system 200) may be able to decrypt the content license; note that this private key may be the private key from the machine credentials issued to the client system by the individualization server. In various embodiments, only a portion of the content license may be encrypted by the license server with the public key from the machine specific credentials. For instance, in some embodiments, the content key of the content license is encrypted by the license server with the public key whereas other portions of the content license are not encrypted with such public key.

Also note that license server 240 may identify the appropriate content license to provide at 258 by matching a content identifier (e.g., a content identifier of protected content 100) from request 256 to a content identifier associated with a particular content license.

Subsequent to receiving the encrypted content license, the DRM component on the client system may decrypt the content license with the private key from the machine credentials 206 (e.g., since the license server may have encrypted the content license as described above). In cases where only a portion of the license is encrypted with the public key of the machine credentials (e.g., a portion including the content key), the DRM component may decrypt that portion with the aforesaid private key. In various embodiments, DRM component 202 may access the content license and usage rules (if any) from the content license and decrypt the corresponding content. If usage rules are present, DRM component 202 may enforce restrictions set forth by those rules. For instance, the DRM component might allow access to the content during a particular period of time (e.g., a rental period) or restrict the actions (e.g., view, cut, copy, paste, etc.) that may be performed on the content. In various embodiments, decrypted content may be consumed (e.g., displayed, played, etc.) by runtime component 204. In one particular example, runtime component 204 may be Adobe® Flash® Player or Adobe® AIR®.

In various embodiments, content license(s) obtained from the license server may be stored as content licenses 208. In various embodiments, DRM component 202 may store content licenses 208 in encrypted form. For instance, DRM component 202 may encrypt a content license with a private key of machine-specific credentials 206. In this way, the content license may be bound to client system 200. For instance, other systems that do not have access to machine-specific credentials 206 may not have access to the public key (of machine-specific credentials 206) that may required to decrypt the aforesaid encrypted content license. In this way, the DRM framework described herein may restrict the use of a particular content license to a particular client system (e.g., client system 200).

### DRM Component Diversification

In various embodiments, the DRM framework of various embodiments may also be configured to perform DRM component diversification. In various embodiments, diversifying a DRM component may include generating multiple versions of the same DRM component (e.g., DRM component 202), such as multiple versions that will be deployed onto different client systems (e.g., over the Internet or some other network), such as client system 200. Each of such versions may in various embodiments be functional equivalents (e.g., each may be capable of performing the same functionalities in the same manner when executed on a computer system) but may differ in other respects. For example, diversifying a DRM component may include generating multiple DRM component versions that include different credentials, such as DRM credentials 210. An example of such a DRM credential may include a public key—private key pair. In this way, each DRM component version may in various embodiments be configured to operate in the same manner; however, the stored representation (e.g., a binary representation stored in memory) of a given DRM component version may be different than the stored representation of another DRM component version. This difference may in various embodiments be caused by the inclusion of different DRM credentials in different versions of the DRM component.

In various embodiments, different degrees of diversification may be utilized. In one embodiment, a highly diversified approach may be implemented. In one example of such an implementation, each DRM component that is deployed may include a DRM credential that is different than all other DRM credentials included within other DRM components that are deployed. In some embodiments, a more relaxed diversification approach may be implemented. For instance, a particular quantity (e.g., a fixed or configurable quantity) of diversified versions may be generated and multiple instances of each version may be deployed. Such an implementation may in various embodiments cause the formation of multiple groups of DRM components (e.g., each DRM component of a given group may include a DRM credential that is the same as the DRM credential of every other DRM component in that group but different than the DRM credentials of DRM components of other groups).

In some embodiments, when individualization server 220 sends machine credentials to client system 200 (as illustrated by response 254), the individualization server may also encrypt the machine credentials with the public key of the DRM credentials described above (in addition to encrypting the machine credentials with the machine-specific key generated from device information). The DRM component on the client machine may also be configured to decrypt the encrypted machine credentials with the private key of the DRM credentials described above if the encrypted machine credentials are encrypted with the corresponding public key of the DRM credentials. In embodiments where diversification is utilized, a security breach of DRM credentials 210 would only affect the DRM components that include DRM credentials 210. In various embodiments, other client systems that include different credentials would not be affected by such a security breach.

In some embodiments, when license server 240 sends a content license to client system 200, the license server may also encrypt the content license with the public key of the DRM credentials described above (in addition to encrypting the content license with the public key of the machine credentials). DRM component 202 on the client machine may also be configured to decrypt the encrypted content license with the private key of the DRM credentials described above if the encrypted content license is encrypted with the corresponding public key of the DRM credentials. In embodiments where diversification is utilized, a security of breach of DRM credentials 210 would only affect the DRM components that include DRM credentials 210. In various embodiments, other client systems that include different credentials would not be affected by such a security breach. Also note that in the event of a security breach of a DRM credential, any client system that includes a DRM component with that credential may obtain a new, secure DRM component with a new DRM credential.

### Example Method(s)

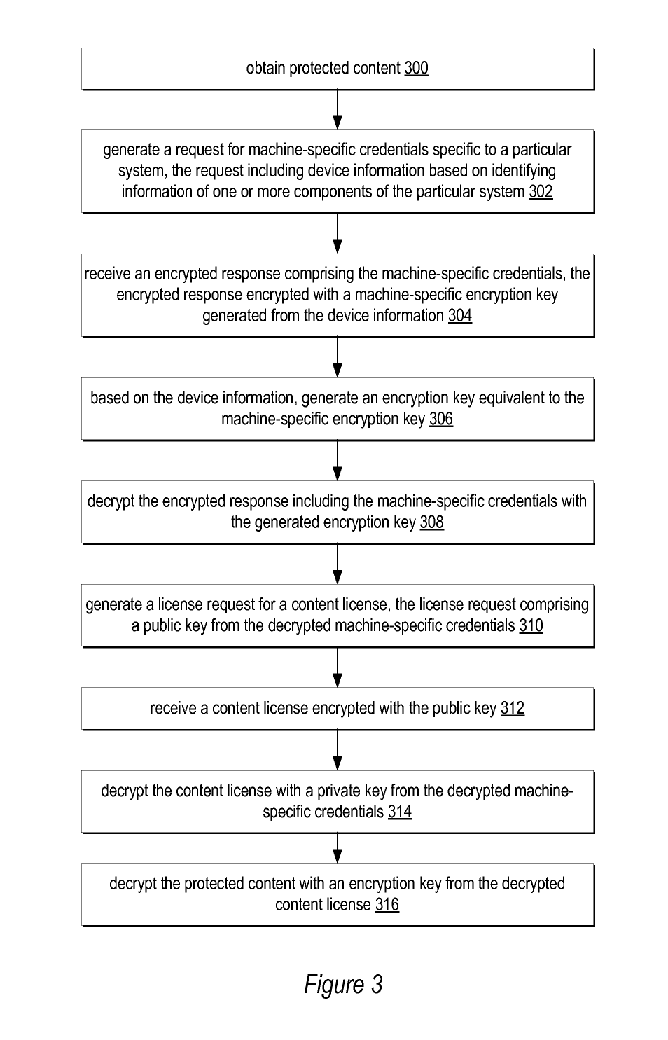

The system and method for digital rights management with system individualization may include various methods, an example of which is illustrated by the flowchart of FIG. 3. In various embodiments, the illustrated method may be performed by the DRM component 202 described above. As illustrated by block 300, the method may include obtaining protected content. In some embodiments, obtaining protected content may include obtaining protected content from a content distribution system as described with respect to FIG. 1 and the receipt of content at 250. As illustrated by block 302, the method may include generating a request for machine-specific credentials specific to a particular system (e.g., client system 200); the request may include device information based on identifying information of one or more components of the particular system. One example of such a request is described above with respect to request 252; the request may in various embodiments be sent to an individualization server (e.g., individualization server 200). As illustrated by block 304, the method may also include receiving an encrypted response comprising the machine-specific credentials; the encrypted response may be encrypted with a machine-specific encryption key generated from the device information. One example of such a response is illustrated by 254 described above. As illustrated by block 306, the method may include, based on at least some of the device information (e.g., processor identifier, motherboard identifier, or any other device information described above), generating an encryption key that is the same as the machine-specific encryption key described with respect to block 304. As illustrated by block 308, the method may also include decrypting the encrypted response including the machine-specific credentials with the generated encryption key (e.g., the encryption key generated at block 306). One example of decrypting such an encrypted response is described above with respect to DRM client 202 decrypting response 254.

In various embodiments, the method may also include acquiring and decrypting a content license for the protected content, as illustrated by block 310-314. For instance, the method may include generating a license request for a content license; the license request may include a public key from the decrypted machine-specific credentials, as illustrated by block 310. One example of such a license request is described above with respect to 256. In some cases, such a request may also include a content identifier or some other information for determining the corresponding content license for the protected content. As illustrated by block 312, the method may also include receiving a content license encrypted with the public key from the machine specific credentials. One example of receiving such an encrypted content license is described above with respect to DRM component 202's receipt of a content license at 258. In various embodiments, only a portion of the content license may be encrypted with the public key from the machine specific credentials. For instance, in some embodiments, the content key of the content license is encrypted with the public key whereas other portions of the content license are not encrypted with such public key. As illustrated by block 314, the method may also include decrypting the content license with a private key from the decrypted machine-specific credentials. In cases where only a portion of the license is encrypted with the public key of the machine credentials (e.g., a portion including the content key), the method may include decrypting that portion with the aforesaid private key. The method may also include decrypting the protected content with an encryption key from the decrypted content license (or a decrypted portion of the content license) in order to generate content that may be consumed, as illustrated by block 316. In some cases, the decrypted content license may also include one or more usage rules (e.g., a rental period during which content may be consumed); the method may include enforcing such rules on the consumption of the content.

FIG. 4 illustrates a flowchart of an example method for determining whether machine credentials may continue to be utilized after a system configuration change that alters device information. In various embodiments, the illustrated method may be performed by the DRM component 202 described above. As illustrated by block 400, the method may include, subsequent to a configuration change causing one or more changes in the device information of a system, determining a new set of device information based on the new configuration of the system. For instance, as described above, the device information (e.g., processor identifier, motherboard identifier, hard drive identifier, etc.) of the client system described above may change in response to a configuration change of any of the components associated with the device information. For instance, if a hard drive of a client system is replaced, the device information associated with the old hard drive will no longer be part of the device information whereas the device information of the new hard drive will be considered for inclusion in the device information of the client system. In general any configuration change can cause corresponding device information to change. In some cases, the information of different components may be weighted independently. For example, a motherboard identifier might by given more weight than a hard drive identifier. In any case, after the configuration change, the method may include determining a new set of device information for a system (e.g., client system 200).

As illustrated by block 402, the method may include determining a measure of similarity between the new set of device information and the device information of the system prior to the configuration change. For instance, in one embodiment, the method may include determining a percentage value representing the similarity between the old device information and the new device information (e.g., the new device information x % the same as the old device information) (also note that this determination may take any independent weighting of different components into consideration).

As illustrated by block 404, the method may include determining whether the measure of similarity is above a threshold value. For instance, the threshold value may specify that the new device information should be x % the same as the old device information. For instance, if at block 402 it is determined that the new device information is 75% the same as the old device information (taking into consideration any weighting factors) and the threshold value is 60%, then the method may include determining that the measure of similarity is above the threshold value (as indicated by the positive output of block 404). If at block 402 it is determined that the new device information is 50% the same as the old device information (taking into consideration any weighting factors) and the threshold value is 60%, then the method may include determining that the measure of similarity is not above the threshold value (as indicated by the negative output of block 404). If the condition at block 404 is met, the method may include utilizing the current machine credentials (e.g., machine credentials 206 described above) (block 406a). If the condition at block 404 is not met, the method may include obtaining new machine-specific credentials for the system (block 406b). In one example, obtaining new machine-specific credentials may include re-performing the individualization process described above. In some embodiments, the method may include prompting a user of the appropriate client system (e.g., via one or more displays) to revert to an older hardware configuration. In some embodiments, the method may include providing a service (e.g., a network-based service provided by an individualization server) that enables the existing machine credentials to work with updated device information.

### Example System Configuration

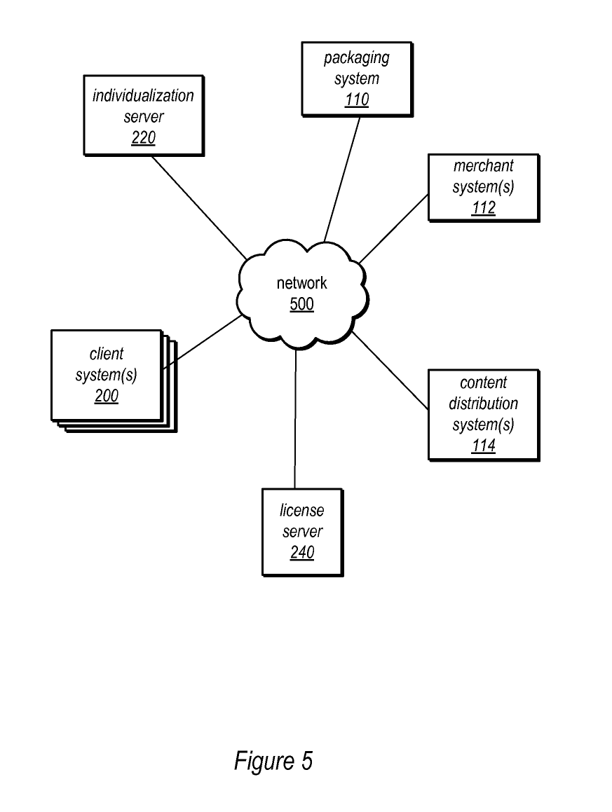

Various embodiments of the system and method for digital rights management with system individualization may be configured according to different system configurations. One example of such a system configuration is illustrated by the system of FIG. 5. In the illustrated embodiment, each of the elements of the DRM framework described above are implemented as elements of respective computer systems. Each of the illustrated computer systems may in various embodiments communicate via a network, such as network 500. Network 500 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, each illustrated element may be a computer system configured to implement the respective components described above via hardware and/or software. Note that any of the elements illustrated in FIG. 5 may be implemented via one or more computer systems, such as the example computer system described below with respect to FIG. 6.

### Example Computer System

Various embodiments of a system and method for digital rights management with system individualization, as described herein, may be executed on one or more computer systems, which may interact with various other devices. One such computer system is computer system 600 illustrated by FIG. 6, which may in various embodiments implement any of the elements illustrated in FIGS. 1-5. Computer system 600 may be configured to implement a DRM component 202 and/or a runtime component 204, which may be stored in memory as processor-executable program instructions 622. In the illustrated embodiment, computer system 600 includes one or more processors 610 coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In some embodiments, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs), such as the x66, PowerPC, SPARC, or MIPS ISAs, or any other suitable ISA. In multiprocessor systems, each of processors 610 may commonly, but not necessarily, implement the same ISA.

System memory 620 may be configured to store program instructions 622 and/or data 632 accessible by processor 610. In various embodiments, data 632 may include protected or unprotected content as described above (e.g., protected content 100) as well as machine specific credentials 206 and content licenses 208. In various embodiments, program instructions 622 may be executable by the processor(s) to implement DRM component 202 and/or runtime component 204. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the DRM framework (as described above), may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 500), such as other computer systems (e.g., individualization server 220, content distribution system 114, and/or license server 240), or between nodes of computer system 600. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the method illustrated by FIGS. 3-4. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the embodiments described herein may be practiced with other computer system configurations.

Various embodiments may further include receiving, sending or storing instructions and/or data implemented in accordance with the foregoing description upon a computer-accessible medium. Generally speaking, a computer-accessible medium may include a storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of methods may be changed, and various elements may be added, reordered, combined, omitted, modified, etc. Various modifications and changes may be made as would be obvious to a person skilled in the art having the benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1. A system, comprising:
a memory; and
one or more processors coupled to the memory, wherein the memory comprises program instructions executable by the one or more processors to implement a digital rights management (DRM) component configured to:
generate a request for machine-specific credentials unique to the system, the request comprising unique device information that is unique to one or more components of said system;
receive an encrypted response comprising the machine-specific credentials, the encrypted response encrypted with a machine-specific encryption key generated from said unique device information;
based on said unique device information, generate an encryption key equivalent to said machine-specific encryption key; and
decrypt the encrypted response comprising the machine-specific credentials with the generated encryption key.

2. The system of claim 1, wherein the DRM component is further configured to:
generate a license request for a content license, the license request comprising a public key from the decrypted machine-specific credentials; and
receive a content license, wherein one or more portions of the content license are encrypted with the public key; and
decrypt the one or more portions of the content license with a private key from the decrypted machine-specific credentials.

3. The system of claim 2, wherein the DRM component is configured to securely store the content license in an encrypted form, wherein the encrypted form of the content license is encrypted with a private key from the machine-specific credentials.

4. The system of claim 2, wherein the DRM component is further configured to decrypt content with an encryption key from the one or more decrypted portions of the content license.

5. The system of claim 4, wherein the DRM component is configured to enforce usage rules on said content, said usage rules from the content license.

6. The system of claim 1, wherein the DRM component is configured to securely store the received machine-specific credentials in an encrypted form in said memory, wherein the machine-specific credentials are encrypted with an encryption key based on device information of one or more components of said system.

7. The system of claim 1, wherein a stored representation of said DRM component in said memory includes a DRM credential specific to the DRM component, wherein said DRM credential is different than one or more DRM credentials included within one or more other DRM components deployed on one or more other systems.

8. The system of claim 7, wherein the received encrypted response comprising the machine-specific credentials is additionally encrypted with a public key from the DRM credential of the DRM component, wherein the DRM component is configured to decrypt the encrypted response comprising the machine-specific credentials with a private key from the DRM credential.

9. The system of claim 7, wherein the DRM component is configured to securely store the received machine-specific credentials in an encrypted form in said memory, wherein the encrypted form of said machine-specific credentials is encrypted by the DRM component with a private key from the DRM credential.

10. The system of claim 1, wherein the DRM component is configured to, subsequent to a configuration change causing one or more changes in the device information for said system:
determine a new set of device information comprising device information for a group of components of said system;
determine a measure of similarity between the new set of device information and the device information of the system prior to said configuration change;
in response to determining that said measure of similarity is above a threshold value, utilize the machine-specific credentials for one or more subsequent content license requests; and
in response to determining that said measure of similarity is not above a threshold value, obtain new machine-specific credentials for said system.

11. A system, comprising:
a memory; and
one or more processors coupled to the memory, wherein the memory comprises program instructions executable by the one or more processors to implement an individualization component configured to:
receive a request for machine-specific credentials unique to a computer system, the request comprising unique device information that is unique to one or more components of the computer system;
based on the unique device information specified by the request, generate a machine-specific encryption key;
generate an encrypted response comprising the machine-specific credentials, the encrypted response encrypted with the generated machine-specific encryption key; and
provide the response to the computer system.

12. The system of claim 11, wherein the request comprises a public key of a DRM component of said computer system, wherein the individualization component is configured to generate the encrypted response such that the encrypted response is encrypted with said public key.

13. The system of claim 11, wherein the individualization component is configured to:
perform a widening function on the device information of the request to determine a result; and
generate the encrypted response such that the machine-specific credentials include an identifier of the computer system, wherein said identifier of the computer system is based on the result of performing the widening function.

14. The system of claim 13, wherein the machine-specific credentials include a digital certificate comprising a public key for the computer system and said identifier.

15. The system of claim 13, wherein the result of the widening function is a Hash Message Authentication Code (HMAC).

16. The system of claim 13, wherein the individualization server is further configured to randomly generate a second identifier of the computer system and include that randomly generated second identifier in the machine-specific credentials generated by the individualization server.

17. A computer-implemented method, comprising:
performing, by one or more computers:
generating a request for machine-specific credentials unique to a computer system, the request comprising unique device information that is unique to one or more components of said computer system;
receiving an encrypted response comprising the machine-specific credentials, the encrypted response encrypted with a machine-specific encryption key generated from said unique device information;
based on said unique device information, generating an encryption key equivalent to said machine-specific encryption key; and
decrypting the encrypted response comprising the machine-specific credentials with the generated encryption key.

18. The method of claim 17, further comprising:
generating a license request for a content license, the license request comprising a public key from the decrypted machine-specific credentials; and
receiving a content license, wherein one or more portions of the content license are encrypted with the public key; and
decrypting the one or more portions of the content license with a private key from the decrypted machine-specific credentials.

19. The method of claim 18, further comprising securely storing the content license in an encrypted form, wherein the encrypted form of the content license is encrypted with a private key from the machine-specific credentials.

20. The method of claim 18, further comprising decrypting content with an encryption key from the one or more decrypted portions of the content license.

21. The method of claim 20, further comprising enforcing usage rules on said content, said usage rules from the content license.

22. The method of claim 17, further comprising securely storing the received machine-specific credentials in an encrypted form in a memory of said computer system, wherein the machine-specific credentials are encrypted with an encryption key based on device information of one or more components of said computer system.

23. The method of claim 17, further comprising, subsequent to a configuration change causing one or more changes in the device information for said computer system:
determining a new set of device information comprising device information for a group of components of said computer system;
determining a measure of similarity between the new set of device information and the device information of the computer system prior to said configuration change;
in response to determining that said measure of similarity is above a threshold value, utilizing the machine-specific credentials for one or more subsequent content license requests; and
in response to determining that said measure of similarity is not above a threshold value, obtaining new machine-specific credentials for said computer system.

24. A computer-implemented method, comprising:
receiving a request for machine-specific credentials unique to a computer system, the request comprising unique device information that is unique to one or more components of the computer system;
based on the unique device information specified by the request, generating a machine-specific encryption key;
generating an encrypted response comprising the machine-specific credentials, the encrypted response encrypted with the generated machine-specific encryption key; and
providing the response to the computer system.

25. The method of claim 24, wherein the request comprises a public key of a DRM component of said computer system, wherein the method comprises generating the encrypted response such that the encrypted response is encrypted with said public key.

26. The method of claim 24, further comprising:
performing a widening function on the device information of the request to determine a result; and
generating the encrypted response such that the machine-specific credentials include an identifier of the computer system, wherein said identifier of the computer system is based on the result of performing the widening function.

27. The method of claim 26, wherein the machine-specific credentials include a digital certificate comprising a public key for the computer system and said identifier.

28. The method of claim 26, wherein the result of the widening function is a Hash Message Authentication Code (HMAC).

29. The method of claim 26, further comprising randomly generating a second identifier of the computer system and including that randomly generated second identifier in the generated machine-specific credentials.

30. A non-transitory computer-readable storage medium, storing program instructions executable on a computer system to implement a DRM component configured to:
generate a request for machine-specific credentials unique to the computer system, the request comprising unique device information that is unique to one or more components of said computer system;
receive an encrypted response comprising the machine-specific credentials, the encrypted response encrypted with a machine-specific encryption key generated from said unique device information;
based on said unique device information, generate an encryption key equivalent to said machine-specific encryption key; and
decrypt the encrypted response comprising the machine-specific credentials with the generated encryption key.

31. The medium of claim 30, wherein the DRM component is further configured to:
generate a license request for a content license, the license request comprising a public key from the decrypted machine-specific credentials; and
receive a content license, wherein one or more portions of the content license are encrypted with the public key; and
decrypt the one or more portions of the content license with a private key from the decrypted machine-specific credentials.

32. The medium of claim 31, wherein the DRM component is configured to securely store the content license in an encrypted form, wherein the encrypted form of the content license is encrypted with a private key from the machine-specific credentials.

33. The medium of claim 31, wherein the DRM component is further configured to decrypt content with an encryption key from the one or more decrypted portions of the content license.

34. The medium of claim 33, wherein the DRM component is configured to enforce usage rules on said content, said usage rules from the content license.

35. The medium of claim 30, wherein the DRM component is configured to securely store the received machine-specific credentials in an encrypted form in memory of said computer system, wherein the machine-specific credentials are encrypted with an encryption key based on device information of one or more components of said system.

36. The medium of claim 30, wherein a stored representation of said DRM component in memory of said computer system includes a DRM credential specific to the DRM component, wherein said DRM credential is different than one or more DRM credentials included within one or more other DRM components deployed on one or more other systems.

37. The medium of claim 36, wherein the received encrypted response comprising the machine-specific credentials is additionally encrypted with a public key from the DRM credential of the DRM component, wherein the DRM component is configured to decrypt the encrypted response comprising the machine-specific credentials with a private key from the DRM credential.

38. The medium of claim 36, wherein the DRM component is configured to securely store the received machine-specific credentials in an encrypted form in said memory, wherein the encrypted form of said machine-specific credentials is encrypted by the DRM component with a private key from the DRM credential.

39. The medium of claim 30, wherein the DRM component is configured to, subsequent to a configuration change causing one or more changes in the device information for said system:
determine a new set of device information comprising device information for a group of components of said system;
determine a measure of similarity between the new set of device information and the device information of the system prior to said configuration change;
in response to determining that said measure of similarity is above a threshold value, utilize the machine-specific credentials for one or more subsequent content license requests; and
in response to determining that said measure of similarity is not above a threshold value, obtain new machine-specific credentials for said system.

40. A non-transitory computer-readable storage medium, storing program instructions computer-executable to implement an individualization server configured to:
receive a request for machine-specific credentials unique to a computer system, the request comprising unique device information that is unique to one or more components of the computer system;
based on the unique device information specified by the request, generate a machine-specific encryption key;
generate an encrypted response comprising the machine-specific credentials, the encrypted response encrypted with the generated machine-specific encryption key; and
provide the response to the computer system.

41. The medium of claim 40, wherein the request comprises a public key of a DRM component of said computer system, wherein the individualization component is configured to generate the encrypted response such that the encrypted response is encrypted with said public key.

42. The medium of claim 40, wherein the individualization component is configured to:
perform a widening function on the device information of the request to determine a result; and
generate the encrypted response such that the machine-specific credentials include an identifier of the computer system, wherein said identifier of the computer system is based on the result of performing the widening function.

43. The medium of claim 42, wherein the machine-specific credentials include a digital certificate comprising a public key for the computer system and said identifier.

44. The medium of claim 42, wherein the result of the widening function is a Hash Message Authentication Code (HMAC).

45. The medium of claim 42, wherein the individualization server is further configured to randomly generate a second identifier of the computer system and include that randomly generated second identifier in the machine-specific credentials generated by the individualization server.
